(19) United States
(12) Patent Application Publication
(10) Pub. No.: US 2024/0045451 A1
(43) Pub. Date: Feb. 8, 2024

(54) DRONE FLIGHT CONTROL DEVICE, CONTROL METHOD THEREFOR, AND STORAGE MEDIUM

(71) Applicant: CANON KABUSHIKI KAISHA, Tokyo (JP)

(72) Inventor: TOMOKO KUDO, Kanagawa (JP)

(21) Appl. No.: 18/348,023

(22) Filed: Jul. 6, 2023

(30) Foreign Application Priority Data
Aug. 2, 2022 (JP) 2022-123517

(51) Int. Cl. G05D 1/10; B64U 50/13; G06V 20/58; G06V 20/17

(52) U.S. Cl. CPC G05D 1/106; B64U 50/13; G06V 20/58; G06V 20/17; B64U 2101/30

(57) ABSTRACT

A drone flight control device that performs flight control of a drone having a plurality of propellers, includes an image sensor including an image capturing unit that has a plurality of pixels arrayed and generates an image signal, and a first subject recognition unit that executes subject recognition processing by using the image signal, a first generation unit configured to generate a control signal for drive control of the propeller on a basis of a recognition result by the first subject recognition unit; and a drive unit configured to drive the propeller on a basis of the control signal from the first generation unit.

### BACKGROUND OF THE INVENTION

### Field of the Invention

The present invention relates to a flight control technology of a drone having a plurality of propellers.

### Description of the Related Art

In recent years, the range of use of a drone (unmanned flying object) has been expanded. In general, a drone is operated manually by remote control, but as a trend, the number of drone crash cases is increasing, which is a social problem.

There are various causes of drone crashes, including contact with an obstacle and bird strikes. In order to avoid these problems, Japanese Patent Laid-Open No. 2019-200758 discloses an automatic operation control method including detecting an obstacle using various sensors (ultrasonic sensor, laser beam sensor, and the like) and recognizing and handing, using AI, an obstacle from an image captured by a camera mounted on a drone.

However, the known technology described in Japanese Patent Laid-Open No. 2019-200758 includes performing subject recognition using image processing or AI on the basis of an image signal read out from the camera mounted on the drone. Therefore, as illustrated in FIG. 10, subject recognition (obstacle recognition) 1002 is delayed by 1 to several frames with respect to readout timing 1001 of a signal of an image sensor. Furthermore, in order to take an action of avoiding the obstacle on the basis of the result, there is a problem that the avoidance action is not in time in a case of flying at a high speed or in a case where the obstacle is flying at a high speed. In particular, since the drone is required to change the flight direction within a range where it does not crash, it takes time to change the direction, and thus it is desirable to detect the obstacle as soon as possible.

Regarding the subject recognition technology, Japanese Patent No. 6635221 discloses an imaging apparatus in which a subject recognition function is mounted in an image sensor that images a subject and outputs an image signal. Use of this image sensor enables subject recognition to be performed in parallel with readout of the image signal. Since the readout method of the image signal can also be changed, subject recognition can also be performed from an image output by performing readout with the number of pixels thinned out to ¼. That is, in a case where the subject can be recognized in the image having ¼ of the number of pixels, the recognition result of the subject can be output earlier than when the readout of all pixels is completed.

However, Japanese Patent No. 6635221 does not consider application of this technology to a drone.

### SUMMARY OF THE INVENTION

The present invention has been made in view of the above-described problems, and enables high-speed subject recognition processing that can handle flight control of a drone.

According to a first aspect of the present invention, there is provided a drone flight control device that performs flight control of a drone having a plurality of propellers, the drone flight control device comprising: at least one processor or circuit configured to function as an image sensor including an image capturing unit that has a plurality of pixels arrayed and generates an image signal, and a first subject recognition unit that executes subject recognition processing by using the image signal; a first generation unit configured to generate a control signal for drive control of the propeller on a basis of a recognition result by the first subject recognition unit; and a drive unit configured to drive the propeller on a basis of the control signal from the first generation unit.

According to a second aspect of the present invention, there is provided a method for controlling a drone flight control device that performs flight control of a drone having a plurality of propellers, the drone flight control device including an image sensor including an image capturing unit that has a plurality of pixels arrayed and generates an image signal, and a first subject recognition unit that executes subject recognition processing by using the image signal, the method comprising: performing first generation of generating a control signal for drive control of the propeller on a basis of a recognition result by the first subject recognition unit; and driving the propeller on a basis of the control signal from the first generation.

Further features of the present invention will become apparent from the following description of exemplary embodiments with reference to the attached drawings.

### BRIEF DESCRIPTION OF THE DRAWINGS

FIG. 1A is a view illustrating a configuration of a drone flight control device of a first embodiment.

FIG. 1B is a view illustrating a configuration of a drone flight control device of the first embodiment.

FIG. 1C is a view illustrating a configuration of a drone flight control device of the first embodiment.

FIG. 1D is a view illustrating a configuration of a drone flight control device of the first embodiment.

FIG. 2 is a timing chart illustrating processing of the drone flight control device of the first embodiment.

FIG. 3 is a timing chart illustrating processing of the drone flight control device of the first embodiment.

FIG. 4A is a view illustrating a configuration of a drone flight control device of a second embodiment.

FIG. 4B is a view illustrating a configuration of a drone flight control device of the second embodiment.

FIG. 5 is an overall view of a drone.

FIGS. 6A to 6F illustrate operation of each propeller of the drone.

FIG. 7A is a view illustrating a configuration of a drone flight control device of the second embodiment.

FIG. 7B is a view illustrating a configuration of a drone flight control device of the second embodiment.

FIG. 8A is a flowchart illustrating the operation of the drone flight control device.

FIG. 8B is a flowchart illustrating the operation of the drone flight control device.

FIG. 8C is a flowchart illustrating the operation of the drone flight control device.

FIG. 9 is a timing chart illustrating processing of the drone flight control device of the first embodiment.

FIG. 10 is a timing chart for explaining recognition processing in a known image processing unit.

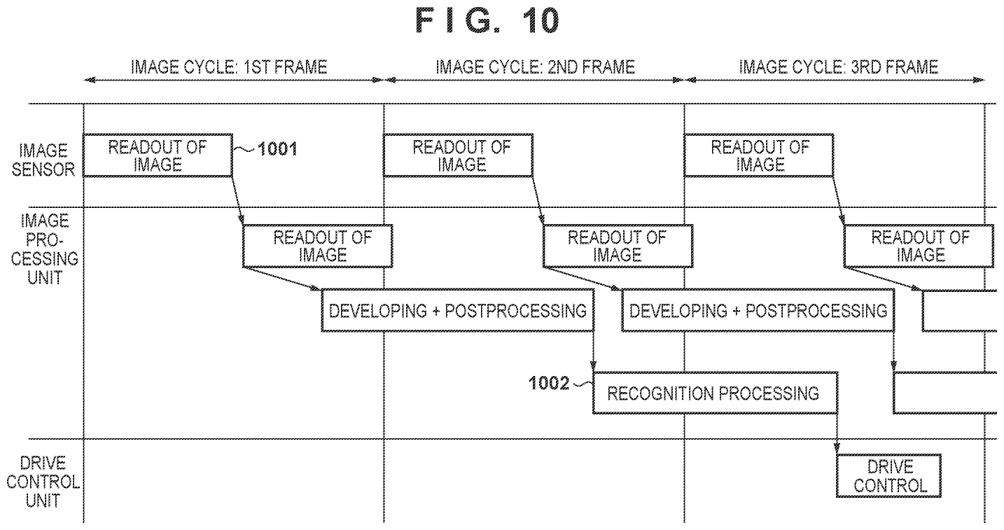

### DESCRIPTION OF THE EMBODIMENTS

Hereinafter, embodiments will be described in detail by referring to the accompanying drawings. The following embodiments do not limit the invention according to the claims. Although a plurality of features is described in the embodiments, some of the plurality of features may not be essential to the invention, and the plurality of features may be arbitrarily combined. Further, in the accompanying drawings, identical or similar components are denoted by identical reference signs, and redundant description will be omitted.

### First Embodiment

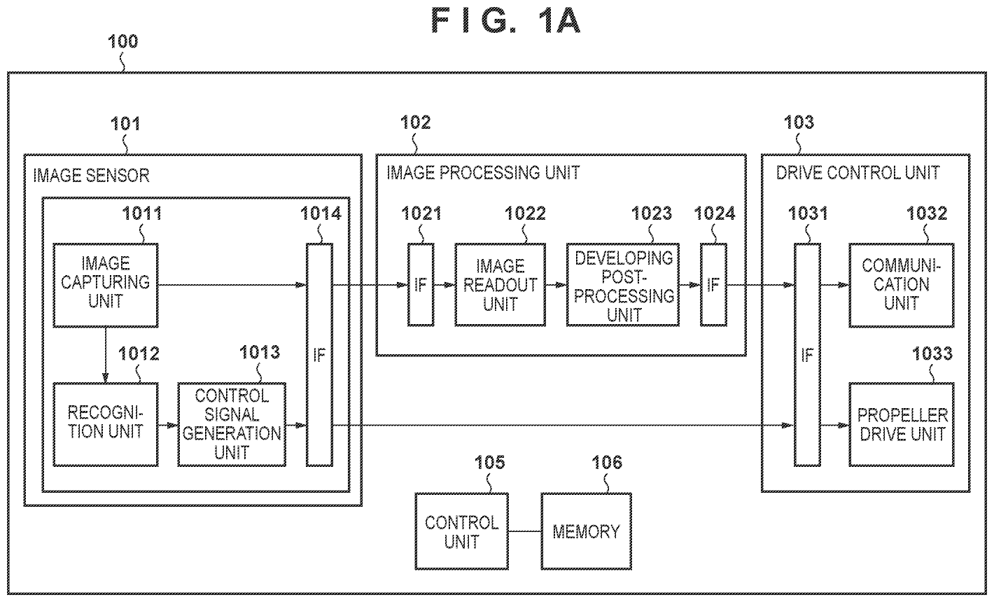

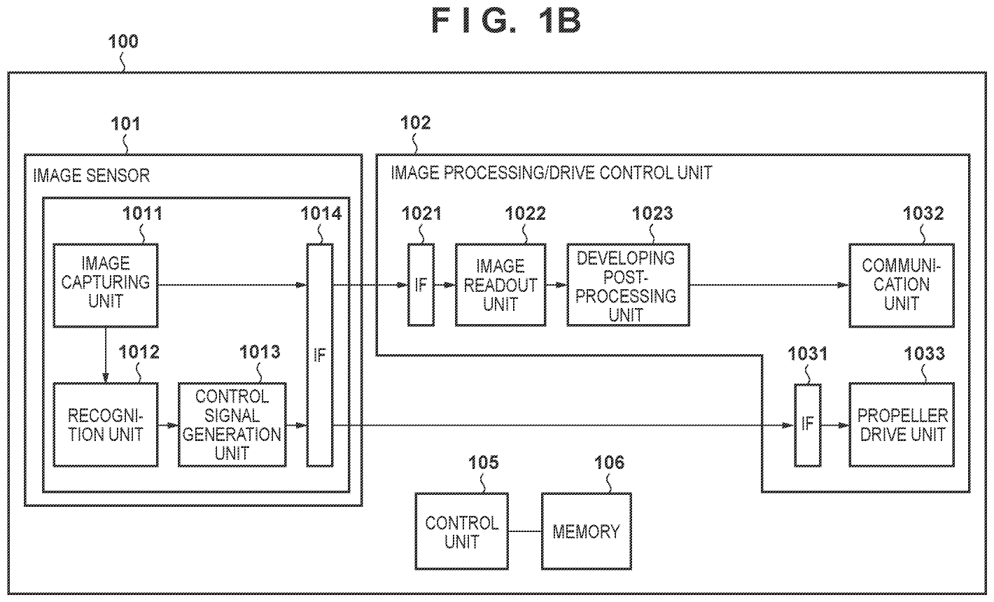

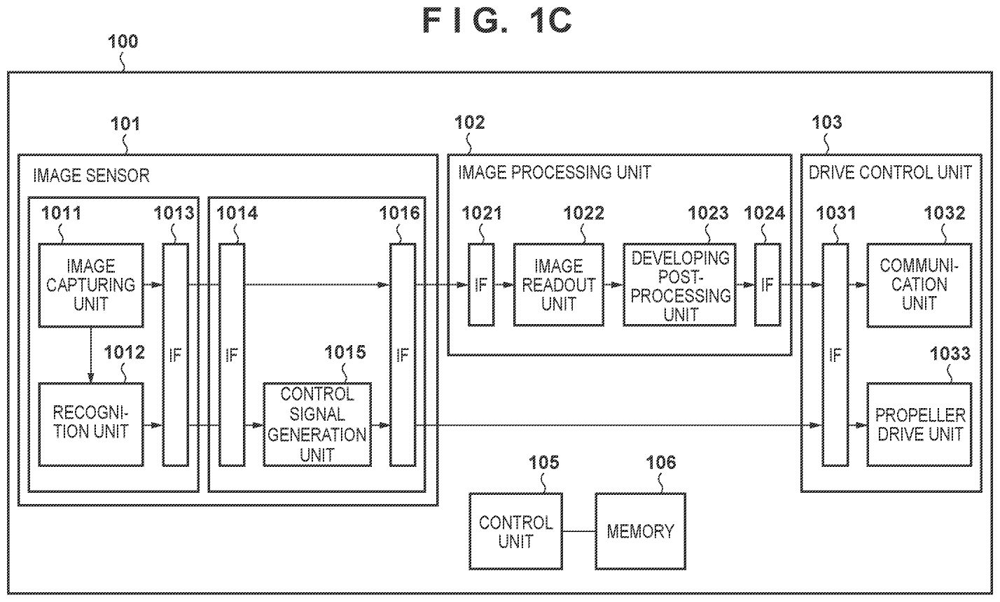

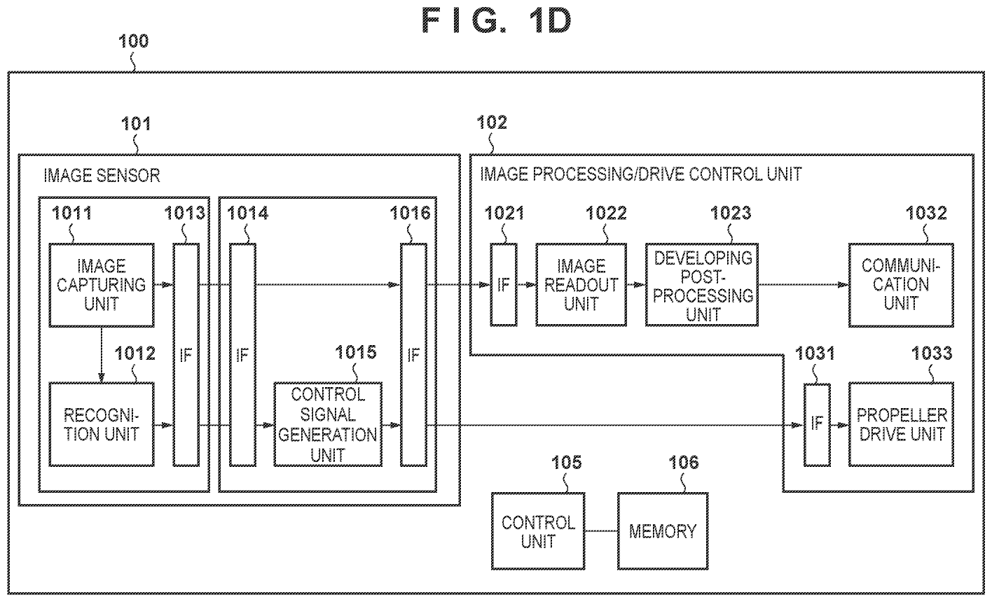

A first embodiment of the present invention will be described below. FIG. 1A is a block diagram illustrating a schematic configuration of a drone flight control device 100 of the present embodiment that performs flight control of a drone (unmanned flying object).

The drone flight control device 100 is mounted on a drone 500 (see FIG. having a plurality of propellers, for example. The drone flight control device 100 includes an image sensor 101 that captures an image around the drone. The image sensor 101 includes an image capturing unit 1011 in which pixels that generate an image signal by photoelectric conversion are two-dimensionally arrayed. The image sensor 101 includes a subject recognition unit 1012 therein, and can perform subject recognition on the basis of the image signal acquired by the image capturing unit 1011. For example, in order to avoid collision with an obstacle and bird strike that cause drone crash, an object that becomes an obstacle such as an electric cable, a tree, and a bird can be detected by subject recognition. Since other objects, persons, buildings, and the like can be recognized, it is also possible to determine whether or not the subject is an obstacle and whether or not avoidance is necessary.

When it is determined that avoidance is necessary, a control signal generation unit 1013 in the image sensor 101 generates a signal for controlling a propeller drive unit 1033 that drives the plurality of propellers of the drone. The control signal generated by the control signal generation unit 1013 is input from the image sensor 101 to an input IF unit 1031 of a drive control unit 103 of each propeller via an output IF unit 1014. In general, since a motor drive unit of a drone performs PWM control, the drive control unit often generates a PWM signal. Therefore, the format of the signal output from the output IF unit 1014 of the image sensor 101 is a format of a serial signal of several bits to several bytes for generating the PWM signal.

The drive control signal of each propeller generated by the image sensor 101 is received by the input IF unit 1031 of the drive control unit 103, and the propeller drive unit 1033 controls the motor of each propeller according to this received control signal.

The drone flight control device 100 of the present embodiment includes an image processing unit 102 that performs image processing for the purpose of capturing an image, inspection, analysis of peripheral information, and the like. The image processing unit 102 receives, via the output IF unit 1014, the image signal output from the image sensor 101, and an image readout unit 1022 rearranges and converts this received image signal into a desired image format. A developing/postprocessing unit 1023 performs various processing such as color and luminance adjustment processing, electronic vibration proofing processing, and lens distortion correction processing on the image signal, and generates a developed image. This image is output to the outside by a communication unit 1032 provided for the drive control unit 103 to receive a remote operation or the like from the user. Alternatively, in a case where a recording unit is provided, the image may be recorded in the drone flight control device 100.

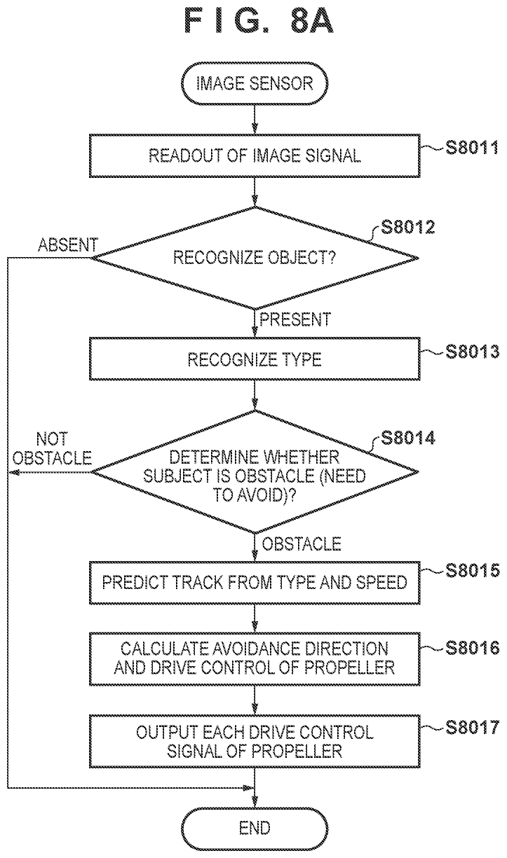

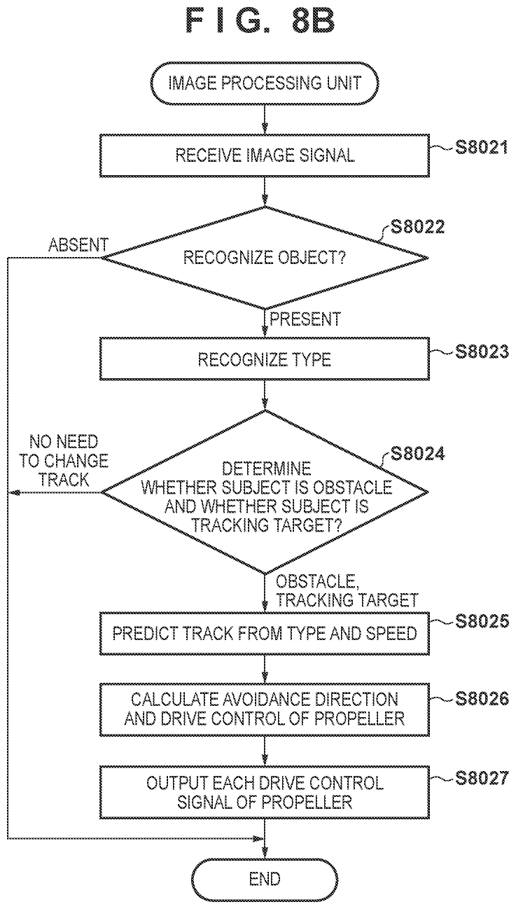

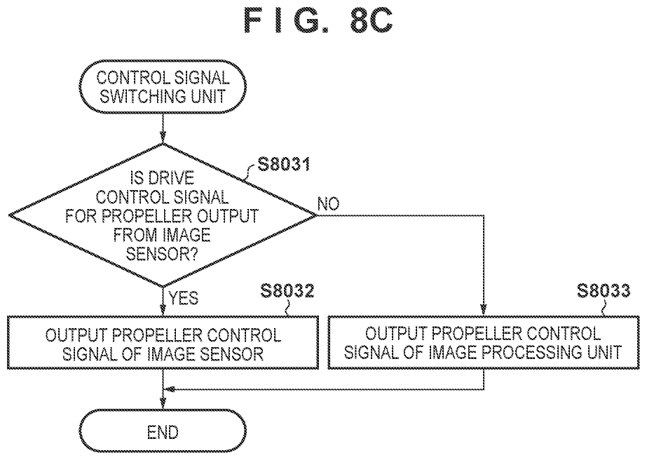

The drone flight control device 100 includes a control unit 105 including a microcomputer for controlling the overall drone control device 100 including the image sensor 101, the image processing unit 102, and the drive control unit 103. By executing a program stored in a memory 106, the control unit 105 performs overall control of the drone control device 100 including the operations of the flowcharts illustrated in FIGS. 8A to 8C.

FIG. 1A illustrates an example in which the image processing unit 102 and the drive control unit 103 are arranged on different substrates. However, in a case where the image processing unit 102 and the drive control unit 103 are formed on the same substrate or the same element, the configuration illustrated in FIG. 1B is adopted.

FIGS. 1A and 1B illustrate a case where the control signal generation unit 1013 in the image sensor 101 is arranged on the same element as the image capturing unit 1011 including a pixel unit. The case corresponds to a case where, for example, the control signal generation unit 1013 and the image capturing unit 1011 have an integrally configured substrate portion (P well or the like) of a semiconductor element, or the substrate portion is connected by a through electrode or the like and configured as an integrated element on a laminate. On the other hand, FIGS. 1C and 1D illustrate a case where the control signal generation unit 1013 is arranged in the image sensor 101 but is a separate element such as a system on chip (SoC).

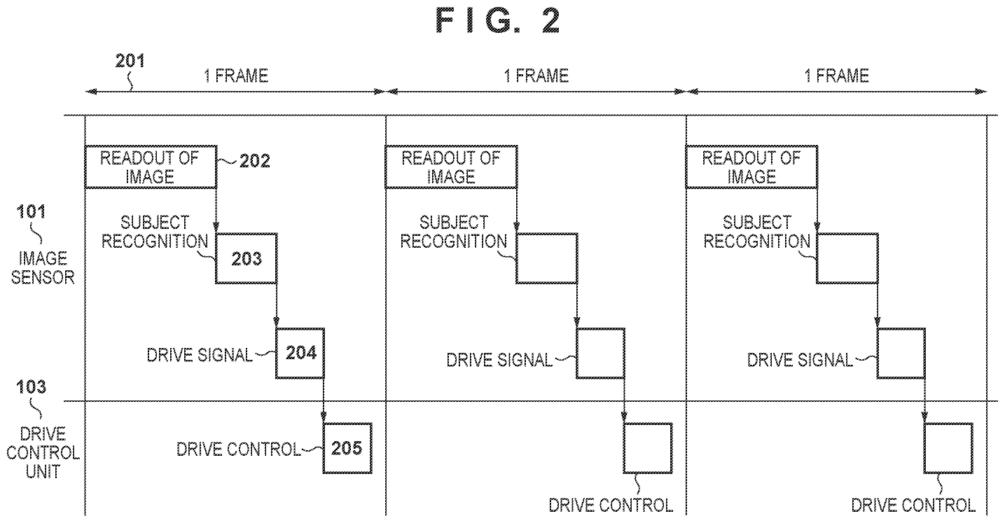

FIG. 2 is a view illustrating operation timing of the drone flight control device 100 of the present embodiment.

A one frame period 201 indicates a period of one frame of the image sensor 101, and is 1/30 seconds in the case of 30 frames per second and 1/60 seconds in the case of 60 frames per second. During the one frame period 201, a readout operation of signals of all pixels of the image sensor 101, indicated by an image readout period 202, is performed. The length of the image readout period 202 is determined by the number of pixels, an operation frequency, a circuit configuration, and the like included in the image sensor 101. In a case where subject recognition is performed using all images in the subject recognition unit 1012 included in the image sensor 101, after the end of the image readout period 202, a subject recognition period 203 for performing subject recognition is started, and a recognition result is output. On the basis of this result, a drive signal of the propeller is generated in a drive signal generation period 204 in the image sensor 101, and the drive control unit 103 performs drive control of the propeller in a drive control period 205.

As described above, in the case where subject recognition is performed in the image sensor 101, since the recognition result is output in the one frame period 201 that is the same as the image readout period 202, the recognition result can be obtained earlier than when subject recognition is performed by an image processing unit in a subsequent stage as in the known case. As a result, the drone can take obstacle avoidance action one to several frames earlier than the known case, and the safety is improved.

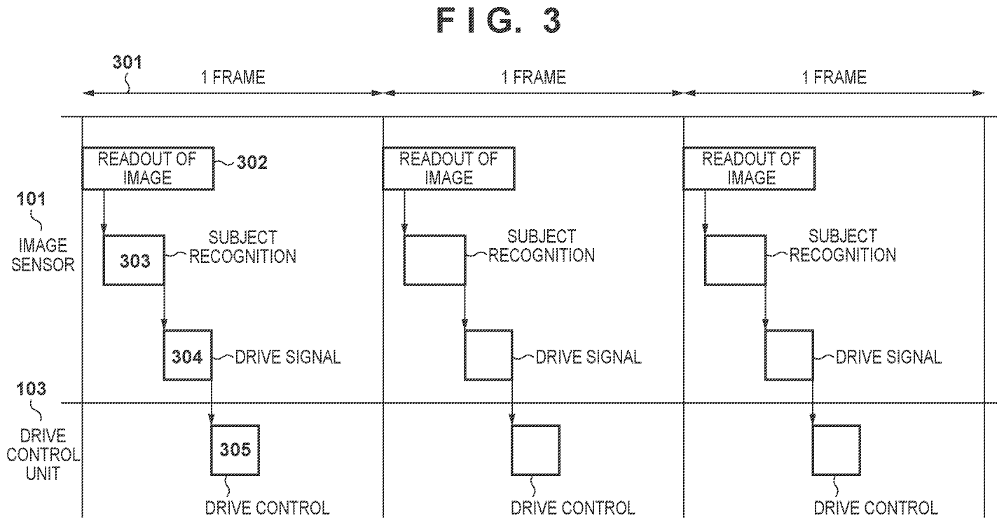

FIG. 3 is a view illustrating timing in a case where subject recognition is performed with ¼ of the total number of pixels of the image sensor 101 by further thinning out pixels to be read. After readout of ¼ of the pixels, that is, after a readout period of ¼ of an image readout period 302 in which all the pixels are read out has elapsed, subject recognition is performed in a subject recognition period 303. Here, in a case where the recognition is successful, after the subject recognition period 303 ends, the drive signal can be generated in a drive signal generation period 304, and the process can transition to a drive control period 305 early. In this case, since a subject recognition result is output earlier than the end of the image readout period 302, which is a readout period for all the images, the flight control can be changed earlier. This improves the collision prevention performance of the drone, and enables a safer flight.

In a case where the subject recognition is not successful with ¼ pixels, ¼ pixels are further read out, and the subject recognition is performed using an image generated by readout of ½ pixels. Furthermore, in a case where recognition is not successful with ½ pixels, the subject recognition is performed using an image obtained by readout of ¾ pixels and 4/4 pixels (all pixels). Since the recognition result can be output at the timing when the subject recognition after the readout with ¼ pixels, ½ pixels, ¾ pixels, and 4/4 pixels is successful, the subject recognition result can be obtained earlier in any case as compared with the known case. Although the case of performing reading with ¼ pixels thinned out has been described, it is also possible to change the thinning rate such as ½ thinning, ⅓ thinning, or ⅕ thinning.

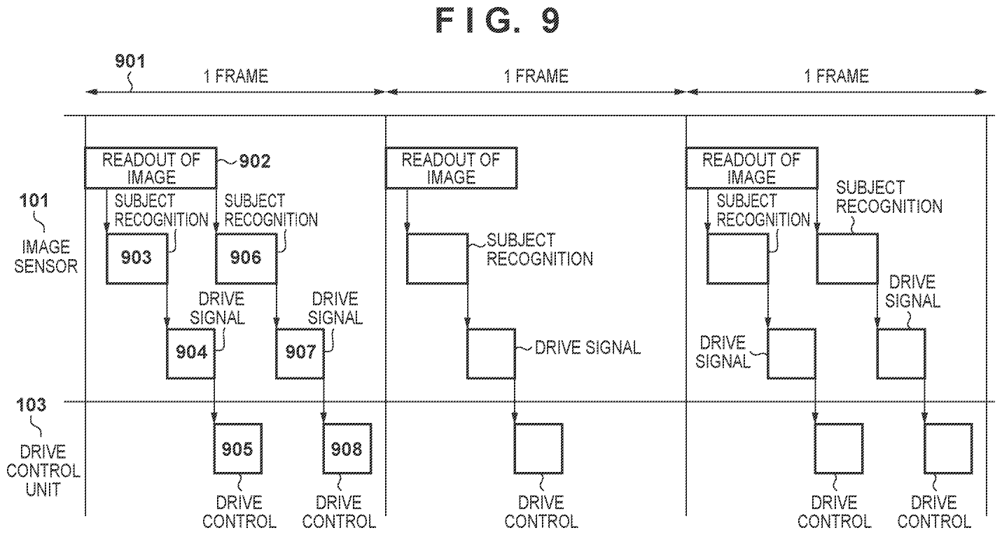

Furthermore, in a case of performing thinning reading, as illustrated in FIG. 9, after generating the drive signal in the drive signal generation period 904 on the basis of the subject recognition in the subject recognition period 903, it is possible to perform the subject recognition again in the subject recognition period 906 in the same frame period. FIG. 9 illustrates a case where subject recognition is performed twice in one frame period, but subject recognition processing can be performed twice or more. The number of times of recognition can be changed for each frame period, and the subject recognition processing can be performed without being synchronized with the frame cycle of the image.

By using an image sensor having a subject recognition function as an image sensor for image capturing, the image sensor for image capturing can also serve as an obstacle detection sensor, and therefore cost reduction can be expected.

### Second Embodiment

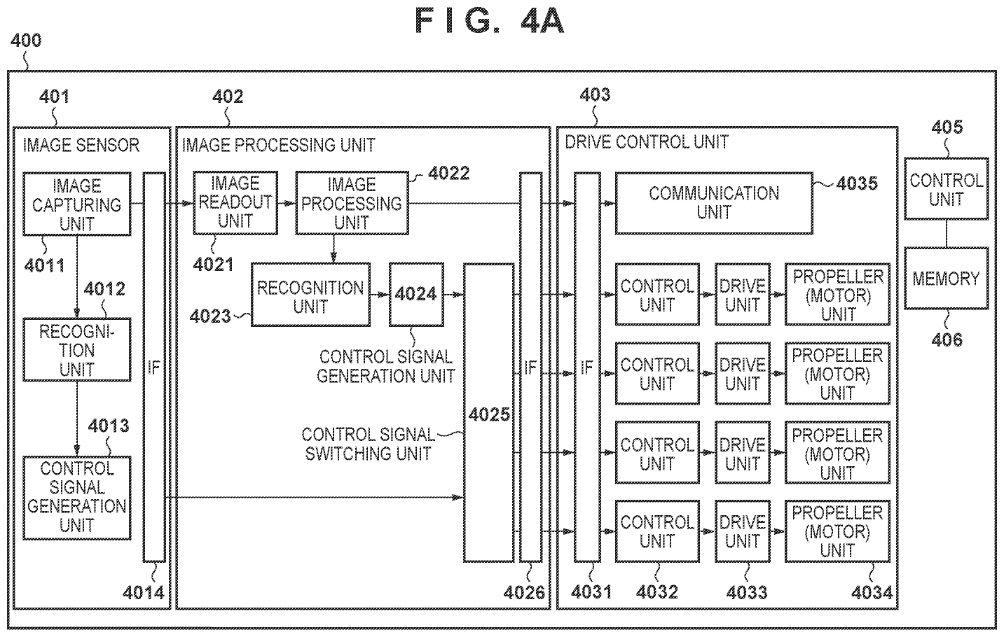

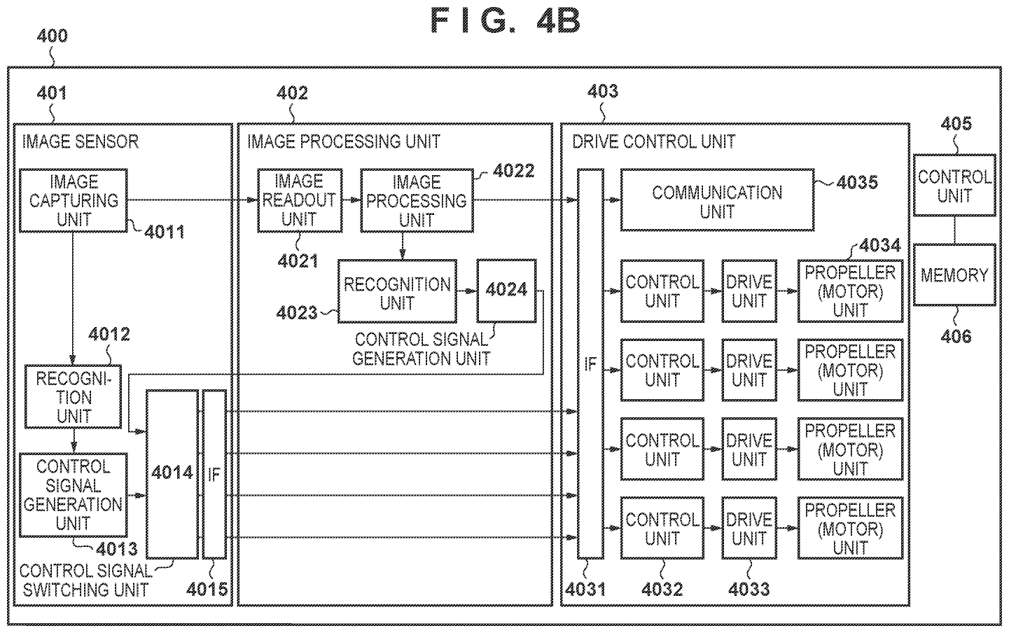

Next, a case where subject recognition is performed also in the image processing unit in a subsequent stage of the image sensor will be described with reference to FIG. 4A.

In the configuration of FIG. 4A, a subject recognition unit 4023 is arranged in an image processing unit 402, and subject recognition processing is performed on a read image. In the subject recognition in the image processing unit 402, after an image sensor 401 ends readout of all images, an image processing unit 4022 performs development processing (color/luminance) and other postprocessing (distortion correction, electronic vibration prevention, and the like) on an image signal via an image readout unit 4021, and generates a developed image. Using this developed image, the subject recognition unit 4023 performs subject recognition processing. Then, a control signal generation unit 4024 generates a control signal on the basis of the subject recognition result.

In the subject recognition processing in the image processing unit 402, recognition processing is performed on an image obtained through readout of all the images in the image sensor 401 and development/postprocessing in the image processing unit 4022. Therefore, as compared with the case where recognition processing is performed by a subject recognition unit 4012 in the image sensor 401, the recognition result is delayed by 1 to several frames as described in the known technology.

However, since the image processing unit 402 is generally higher in the circuit scale and the integration degree than the image sensor 401, the subject recognition unit 4023 of the image processing unit 402 can perform subject recognition with higher accuracy than the subject recognition unit 4012 in the image sensor 401. Therefore, in a case where the degree of urgency is low, regarding, for example, avoidance of an obstacle seen in the distance, tracking in a case where there is a tracking function, and the like, flight control based on accurate information can be performed when the subject recognition processing is performed by the subject recognition unit 4023 of the image processing unit 402. On the other hand, in a case where avoidance is urgently necessary, for example, in a case where there is an obstacle in front after a direction change, a flying bird approaches at high speed while changing its direction, or the like, the recognition result is output earlier in the subject recognition processing in the subject recognition unit 4012 in the image sensor 401. Therefore, the obstacle can be detected early, and a control signal generation unit 4013 can generate a control signal early.

In order to take advantage of both, in the present embodiment, the subject recognition units 4012 and 4023 are provided in the image sensor 401 and the image processing unit 402, respectively. Furthermore, the image processing unit 402 includes a control signal switching unit 4025 for switching the control signals output from the two control signal generation units 4013 and 4024 between emergency and non-emergency.

For example, in the present embodiment, the control signal is output from the image sensor 401 only in a case where the subject recognition unit 4012 detects an obstacle and emergency avoidance is determined to be necessary. Therefore, in a case where the control signal is output from the image sensor 401, switching is performed so as to use the control signal of the image sensor 401. Alternatively, which control signal to use is output as a data signal of about 1 bit, and the control signal to use is switched on the basis of this 1-bit data. These methods make it possible to switch which control signal to use.

The control signal switching unit 4025 switches which control signal of the image sensor 401 or the image processing unit 402 to use, and transmits the selected control signal to an input IF unit 4031 of a drive control unit 403 in a subsequent stage via an output IF unit 4026. In the present embodiment, the format of this control signal is a format of a serial signal of several bits to several bytes for generating the PWM signal, similarly to the first embodiment.

The drone may have a plurality of propellers such as, for example, four, six, or eight propellers, and independent control is required for each propeller.

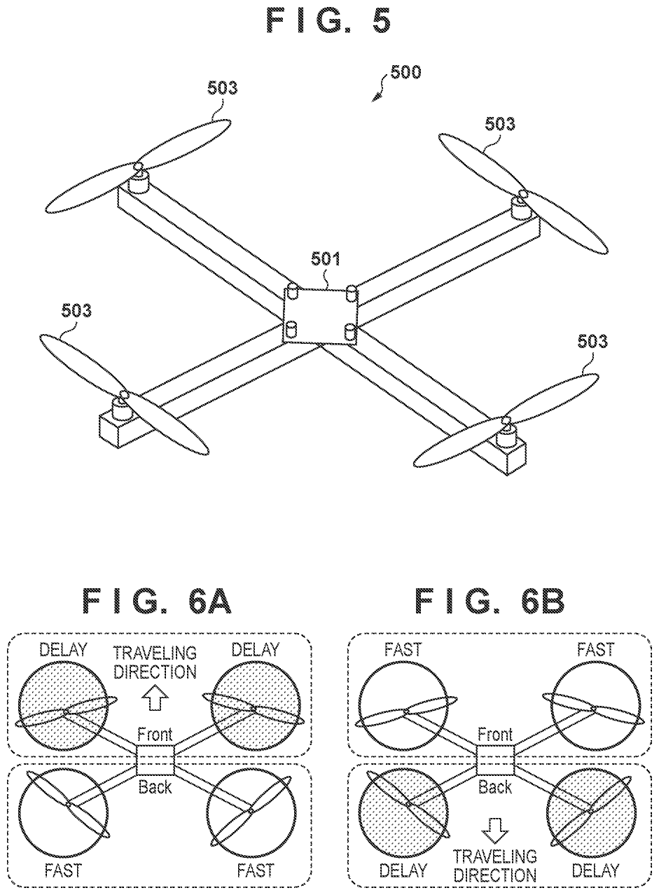

FIG. 5 illustrates a configuration example of the drone in the case of four propellers. The drone 500 includes a substrate 501 on which an image processing unit, a drive control unit, and the like are mounted, and propellers 503 that rotate when flying. Although an image sensor, a lens, and the like are not illustrated, they can be installed on a lower side, a traveling direction side, or a plurality of places of the substrate 501. The substrate 501 may be installed at another position or may be installed at a plurality of places.

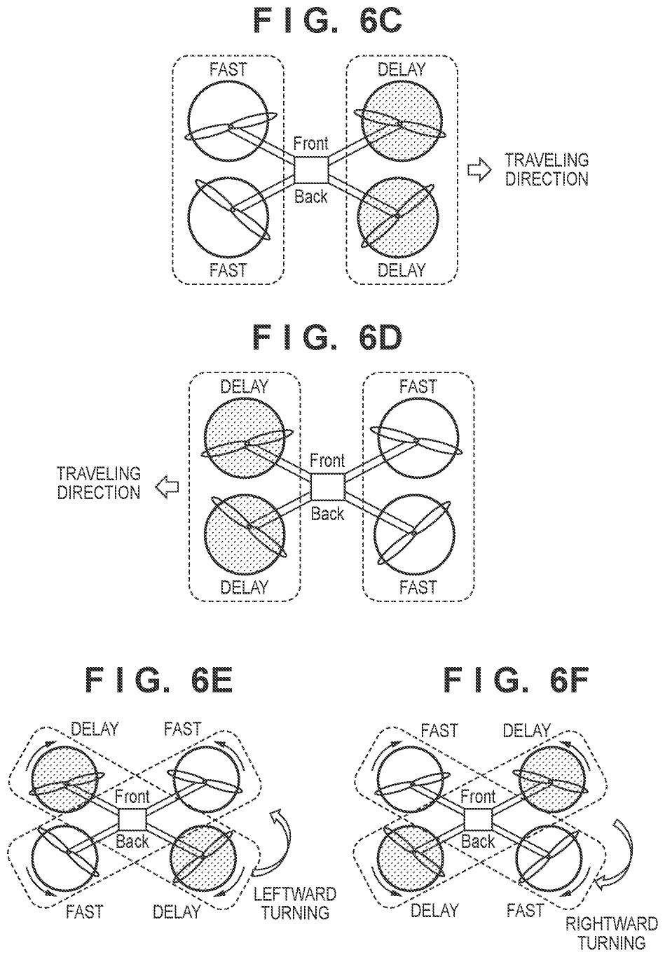

FIGS. 6A to 6F illustrate a control method in a case where the drone is configured to include four propellers as illustrated in FIG. 5. FIGS. 6A and 6B illustrate a control method in a case where the traveling direction is a front-rear direction (forward travel and rearward travel), and FIGS. 6C and 6D illustrate a control method in a case where the traveling direction is a left-right direction (leftward travel and rightward travel). In this case, the rotation speed of the two propellers on the opposite side with respect to the traveling direction is increased. The control is performed so as to travel in one direction by making a difference in the rotation speed on the traveling direction side and the opposite side.

FIGS. 6E and 6F illustrate control methods in a case of performing rightward turning and leftward turning. In the case of performing leftward turning as illustrated in FIG. 6E, the rotation speed of the propeller rotating leftward is increased. In the case of performing rightward turning as illustrated in FIG. 6F, the rotation speed of the propeller rotating rightward is increased. Since the propellers positioned on the diagonal line often have the same rotation direction, the same control is performed on the propellers positioned on the diagonal line. As described above, the drone flight control device is required to independently control each propeller according to the traveling direction and the turning direction.

Therefore, in the case of the configuration having four propellers, the control signals output from the control signal generation units 4013 and 4024 and the control signal switching unit 4025 in FIG. 4A are signals for the four propellers. In this case, the control signals of the respective propellers may be transmitted by four signal lines, or the control signals of the four propellers may be transmitted by serial communication or the like by one signal line.

Furthermore, since the drone crashes when the angle of the airframe exceeds the control limit, it is necessary to perform control so as to gradually change the attitude so that the airframe angle does not exceed the control limit while comparing with the control signal before the change. Also in a case of switching to a control signal output from the image sensor in an emergency, the control signal is changed so as not to crash while comparing with the control signal having been output from the image processing unit.

FIG. 4A described above illustrates an example in which the control signal switching unit 4025 is arranged in the image processing unit 402, but FIG. 4B illustrates an example in which the control signal switching unit 4025 is arranged in the image sensor 401.

In FIG. 4B, a control signal switching unit 4014 (corresponding to the control signal switching unit 4025 in FIG. 4A) is arranged in the image sensor 401. A control signal output from each of the control signal generation units 4013 and 4024 is input to the control signal switching unit 4014, and any of the control signals is selected similarly to the case of FIG. 4A and output from an output IF unit 4015. In this case, the image sensor 401 is required to output a control signal in a signal format and an operation frequency that can be received by the input IF unit 4031 of the drive control unit 403. Therefore, the output IF unit 4015 of the image sensor 401 needs a driver circuit or the like for adjusting the signal format and the operation frequency to those of the input IF unit 4031.

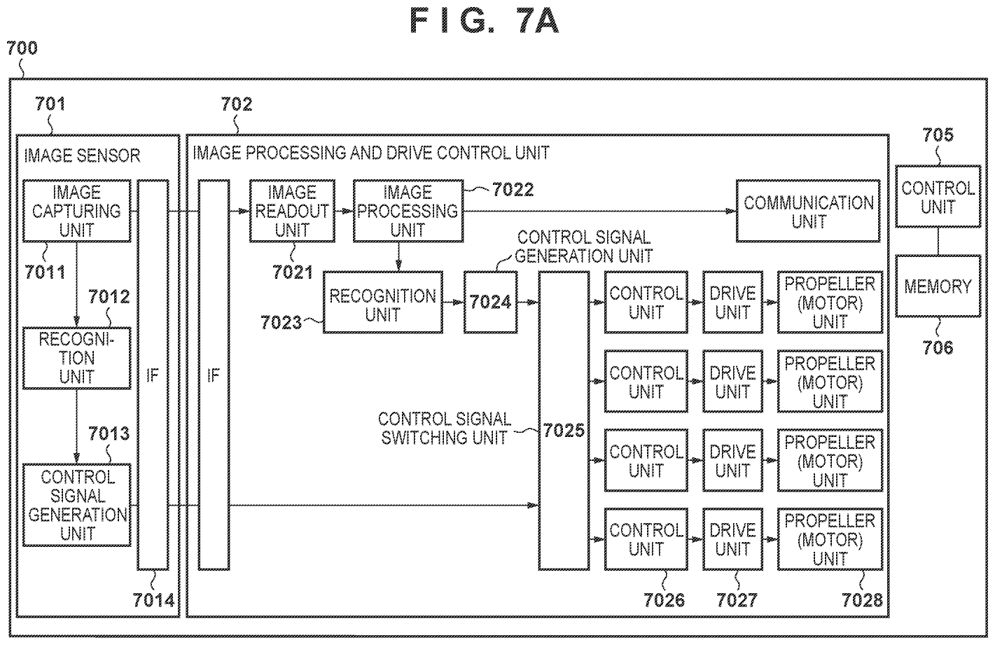

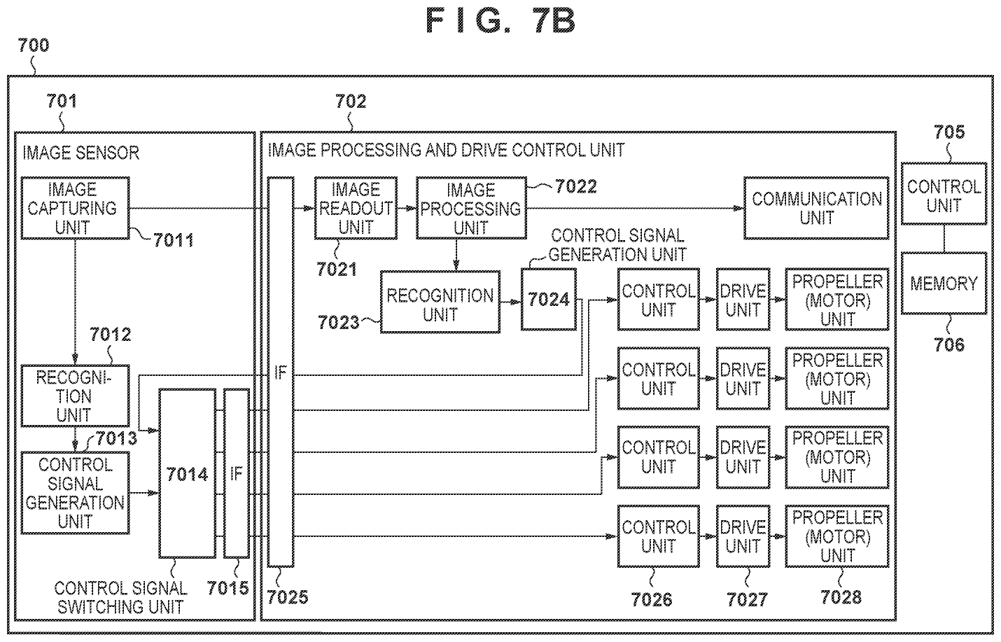

In a case where the image processing unit and the drive control unit are formed on the same substrate or the same element, for example, the configurations illustrated in FIGS. 7A and 7B are conceivable.

As described above, according to the present embodiment, in a non-emergency, flight control can be performed using a more accurate recognition result of the image processing unit, and in an emergency, flight control can be performed using a recognition result obtained at an early timing that is not synchronized with the image cycle. This can further improve flight safety of the drone.

### Third Embodiment

In the first and second embodiments, the control has been described in which the subject recognition unit in the image sensor performs subject recognition to avoid an obstacle. In the present embodiment, a flow of a series of processing of performing subject recognition processing, determining whether an obstacle is present, whether avoidance is necessary, or whether to be a tracking target according to the type of the recognized subject, and changing the trajectory for avoiding according to the type of the obstacle will be described. Here, a case where the configuration of the drone is the configuration of FIG. 4A of the second embodiment will be described as an example.

FIGS. 8A to 8C are flowcharts illustrating the flow of processing of the image sensor 401, the image processing unit 402, and the control signal switching unit 4025. The operation of these flowcharts is implemented by a control unit 405 executing a program stored in a memory 406.

FIG. 8A is a flowchart illustrating the operation of the image sensor 401.

First, in step S8011, the control unit 405 reads out an image signal from an image capturing unit 4011 of the image sensor 401.

In step S8012, the control unit 405 uses the subject recognition unit 4012 to perform subject recognition on the image signal from the image capturing unit 4011, and determines whether or not the subject (object) is present in the image. The control unit 405 proceeds with the processing to step S8013 in a case where the subject is present, and ends this flow in a case where the subject is not present.

In step S8013, the control unit 405 uses the subject recognition unit 4012 to specify the type of subject (e.g., an electric cable, a tree, a bird, a building, a wall, a person, and the like).

In step S8014, the control unit 405 uses the subject recognition unit 4012 to determine whether or not the subject is an obstacle from the type of the subject specified in step S8013. The control unit 405 proceeds with the processing to step S8015 in a case where the subject is an obstacle, and ends this flow in a case where the subject is not an obstacle.

In step S8015, the control unit 405 uses the control signal generation unit 4013 to predict the track of the obstacle from the type and speed of the obstacle.

In step S8016, the control unit 405 uses the control signal generation unit 4013 to determine the avoidance direction for avoiding the obstacle, and calculates the drive control signal of the propeller. Specifically, for example, in a case where the obstacle is an electric cable, it is predicted to extend in one direction, and thus a direction different from the direction is set as the avoidance direction. In a case where the obstacle is recognized as a tree, the avoidance direction is determined according to whether to be a single tree, a plurality of trees, or an assembly (forest or mountain), and further according to how the branches stretch, a height, and the like according to the type of the tree. In the case of not a stationary object but a flying object, the avoidance direction is determined by predicting the flying direction depending on whether to be a flying object (drone, airship, airplane, and the like) or a bird, and further, the speed, the type of the flying object, and the type of the bird. The drive control signal of the propeller is calculated on the basis of the avoidance direction determined in this manner.

In step S8017, the control unit 405 uses the control signal generation unit 4013 to output the drive control signal calculated in step S8016 from the image sensor 401 and input the same to the control signal switching unit 4025.

Next, FIG. 8B is a flowchart illustrating the operation of the image processing unit 402.

First, in step S8021, the control unit 405 receives the image signal output from the image sensor 401.

In step S8022, the control unit 405 uses the subject recognition unit 4023 to perform subject recognition on the image signal from the image sensor 401, and determines whether or not the subject (object) is present in the image. The control unit 405 proceeds with the processing to step S8023 in a case where the subject is present, and ends this flow in a case where the subject is not present.

In step S8023, the control unit 405 uses the subject recognition unit 4023 to specify the type of subject (e.g., an electric cable, a tree, a bird, a building, a wall, a person, and the like).

In step S8024, the control unit 405 uses the subject recognition unit 4023 to determine, from the type of the subject specified in step S8023, whether or not the subject is an obstacle, and in a case where there is a tracking mode, whether or not the subject is a tracking target. The control unit 405 proceeds with the processing to step S8025 in a case where the subject is an obstacle or a tracking target, and ends this flow in a case where the subject is not an obstacle or a tracking target.

In step S8025, the control unit 405 uses the control signal generation unit 4024 to predict the track of the obstacle from the type and speed of the obstacle or the tracking target.

In step S8026, the control unit 405 uses the control signal generation unit 4024 to determine the avoidance direction for avoiding the obstacle or the direction for tracking, and calculates the drive control signal of the propeller.

In step S8027, the control unit 405 uses the control signal generation unit 4024 to output, to the control signal switching unit 4025, the drive control signal calculated in step S8026.

Next, FIG. 8C is a flowchart illustrating the operation of the control signal switching unit 4025.

First, in step S8031, the control unit 405 determines whether or not a drive control signal for the propeller is output from the image sensor 401. The control unit 405 proceeds with the processing to step S8032 in a case where the drive control signal has been output from the image sensor 401, and proceeds with the processing to step S8033 in a case where the drive control signal has not been output.

In step S8032, the control unit 405 switches the output of the control signal switching unit 4025 to the drive control signal from the image sensor 401 (the drive control signal from the control signal generation unit 4013).

In step S8033, the control unit 405 switches the output of the control signal switching unit 4025 to the drive control signal from the control signal generation unit 4024.

In step S8031, the control signal generation unit 4013 may transmit, together with the drive control signal, data indicating whether or not to use the drive control signal from the image sensor 401, and the control signal switching unit 4025 may check this data to determine whether or not to use the drive control signal of the image sensor 401.

As described above, in the present embodiment, since it is possible to specify the type of the obstacle by the subject recognition processing, predict the shape, action, and speed from the type, and determine the avoidance direction, it is possible to further improve the flight safety of the drone.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-123517, filed Aug. 2, 2022, which is hereby incorporated by reference herein in its entirety.

What is claimed is:

1. A drone flight control device that performs flight control of a drone having a plurality of propellers, the drone flight control device comprising:
at least one processor or circuit configured to function as
an image sensor including an image capturing unit that has a plurality of pixels arrayed and generates an image signal, and a first subject recognition unit that executes subject recognition processing by using the image signal;
a first generation unit configured to generate a control signal for drive control of the propeller on a basis of a recognition result by the first subject recognition unit; and
a drive unit configured to drive the propeller on a basis of the control signal from the first generation unit.

2. The drone flight control device according to claim 1, wherein a recognition result of a subject is output from the first subject recognition unit in a frame period in which the image signal is read out from the image capturing unit.

3. The drone flight control device according to claim 1, wherein a recognition result of a subject is output from the first subject recognition unit before readout of the image signal from the image capturing unit ends.

4. The drone flight control device according to claim 1, wherein a recognition result of a subject is output from the first subject recognition unit without being synchronized with a cycle of reading out the image signal of one frame from the image capturing unit.

5. The drone flight control device according to claim 1, wherein the image sensor used for the subject recognition processing is used as an image sensor for capturing an image.

6. The drone flight control device according to claim 1, wherein the at least one processor or circuit is configured to further function as a second subject recognition unit arranged outside the image sensor; a second generation unit configured to generate a control signal for drive control of the propeller on a basis of a recognition result of the second subject recognition unit; and a switching unit configured to switch and inputs, to the drive unit, a control signal from the first generation unit and a control signal from the second generation unit.

7. The drone flight control device according to claim 6, wherein the second subject recognition unit and the second generation unit are arranged in an image processing unit.

8. The drone flight control device according to claim 7, wherein the switching unit is arranged in the image processing unit.

9. The drone flight control device according to claim 6, wherein the switching unit is arranged in the image sensor.

10. The drone flight control device according to claim 9, wherein a control signal generated by the second generation unit is transmitted to the switching unit arranged in the image sensor.

11. The drone flight control device according to claim 10, wherein the image sensor further includes an output device that outputs a control signal switched by the switching unit to the drive unit.

12. The drone flight control device according to claim 6, wherein the switching unit changes a control signal in such a manner that an angle of an airframe of the drone does not exceed a control limit.

13. The drone flight control device according to claim 1, wherein the control signal is a serial signal for generating a PWM signal for driving a motor.

14. The drone flight control device according to claim 6, wherein the first and second subject recognition units further specify a type and speed of a subject.

15. The drone flight control device according to claim 14, wherein the first and second subject recognition units determine whether or not avoidance is necessary according to a type or speed of a specified subject.

16. The drone flight control device according to claim 15, wherein the first and second subject recognition units predict a motion according to a type or speed of a specified subject and determine an avoidance direction.

17. The drone flight control device according to claim 1, wherein a control signal for driving the propeller is a signal for increasing a rotation speed of a propeller on an opposite side with respect to a traveling direction in a case of forward travel, rearward travel, rightward travel, and leftward travel.

18. The drone flight control device according to claim 1, wherein a control signal for driving the propeller is a signal for increasing a rotation speed of a propeller rotating rightward in a case of rightward turning.

19. The drone flight control device according to claim 1, wherein a control signal for driving the propeller is a signal for increasing a rotation speed of a propeller rotating leftward in a case of leftward turning.

20. A method for controlling a drone flight control device that performs flight control of a drone having a plurality of propellers, the drone flight control device including an image sensor including an image capturing unit that has a plurality of pixels arrayed and generates an image signal, and a first subject recognition unit that executes subject recognition processing by using the image signal, the method comprising:
performing first generation of generating a control signal for drive control of the propeller on a basis of a recognition result by the first subject recognition unit; and
driving the propeller on a basis of the control signal from the first generation.

21. A computer-readable storage medium storing a program for causing a computer to function as each unit of the drone flight control device that performs flight control of a drone having a plurality of propellers, the drone flight control device comprising:
at least one processor or circuit configured to function as
an image sensor including an image capturing unit that has a plurality of pixels arrayed and generates an image signal, and a first subject recognition unit that executes subject recognition processing by using the image signal;
a first generation unit configured to generate a control signal for drive control of the propeller on a basis of a recognition result by the first subject recognition unit; and
a drive unit configured to drive the propeller on a basis of the control signal from the first generation unit.
